(19) United States
(12) Patent Application Publication
(10) Pub. No.: US 2006/0255642 A1
(43) Pub. Date: Nov. 16, 2006

(54) Automobile vehicle seat equipped with armrests

(76) Inventors: David Epaud, Cerny (FR); Francois Fourrey, Corquilleroy (FR)

Correspondence Address: BACHMAN & LAPOINTE, P.C., 900 CHAPEL STREET, SUITE 1201, NEW HAVEN, CT, 06510, US

(21) Appl. No.: 11/431,975

(22) Filed: May 10, 2006

(30) Foreign Application Priority Data
May 13, 2005 (FR) 0504803

(51) Int. Cl. B60N 2/46

(52) U.S. Cl. 297/411.38

(57) ABSTRACT

An automobile vehicle seat has a backrest, at least one armrest installed so as to pivot between a utilisation position, in which the armrest presents a bearing face more or less horizontal towards the front of the backrest and a stowed position, in which the armrest lies along a lateral face of the backrest, more or less vertical. The pivoting axis is inclined with regard to the lateral face in such a manner that, in stowed position, the bearing face is opposite the lateral face of the backrest.

### BACKGROUND OF THE INVENTION

(1) Field of the Invention

The present invention relates to an automobile vehicle seat equipped with armrests.

(2) Prior Art

Automobile vehicle seats are sometimes equipped with armrests to improve passenger comfort. For example, a seat is known comprising a backrest on which two armrests are installed so as to pivot on the backrest around a transverse axis of the vehicle, that is more or less horizontal and parallel to the front face of the backrest. Thus, the user of the seat can choose either to use the armrests or to retract them along the lateral faces of the backrest. So that the armrest will be comfortable, its width is for example several centimetres.

Certain vehicles are designed so that the unused seats can be placed in a stowage position in which several seats can be placed side by side, for example by sliding the seats in tracks towards the rear of the vehicle. However, when seats with armrests are provided, their overall widthwise size is greater than that of seats without armrests, which does not allow the layout of the seats to be optimised in stowage position within the width of the vehicle.

### SUMMARY OF THE INVENTION

The aim of the present invention is to provide a seat equipped with armrests the overall size of which is limited widthwise when the armrests are not used.

With these targets in mind, the subject of the invention is an automobile seat comprising a backrest, at least one armrest installed so as to pivot around a pivoting axis between a utilisation position, in which the armrest offers a bearing face more or less horizontal towards the front of the backrest, and a stowed position, in which the armrest lies along a lateral face of the backrest, more or less vertical. The pivoting axis of the armrest is inclined in relation to the lateral face so that, in stowed position, the bearing face is opposite the lateral face of the backrest.

When the armrest is in stowed position, the overall widthwise size of the seat is determined by the position of the lower face of the armrest. It is however possible to approach this position towards the backrest by adjusting the thickness of the armrest or the stowed position of the armrest.

In a specific manner, the axis is inclined, from the outside of the lateral face, towards the bottom and towards the rear of the backrest. The trajectory of a longitudinal edge of the armrest is thus inscribed more or less in a cone the axis of which is the axis of the pivot and where one of the generatrices is parallel to the lateral face of the backrest and where another generatrix is oriented in the main direction of the armrest in utilisation position. When passing from one position to the other, the armrest is located beyond the lateral face of the backrest.

According to a specific arrangement, the lateral face of the backrest comprises a recess in which the armrest is housed in stowage position. Thus, when the armrest is stowed, the width of the backrest is increased only by the distance by which the armrest protrudes from the recess. The overall size of the seat with the armrest in stowed position is reduced in comparison with the prior art.

In a specific manner, the armrest has a thickness much lower than its width. Whether the backrest comprises a recess or not, the overall size of the seat with such an armrest in stowed position is thus also reduced in comparison with the prior art.

According to an embodiment, the pivoting axis consists of a pivot attached to a framework of the backrest.

According to an improvement, the seat comprises locking means to maintain the armrest in stowed position and to free it on request.

### BRIEF DESCRIPTION OF THE DRAWINGS

The invention will be more readily understood and other features and advantages will become apparent on reading the following description. The description refers to the accompanying drawings in which:

FIG. 1 is a front face view of a seat in accordance with the invention with the armrests in stowed position;

FIG. 2 is a perspective view of the seat shown on FIG. 1, with the armrests in utilisation position;

FIG. 3 is a perspective view of an armrest in stowed position;

FIG. 4 is a view similar to FIG. 1, the armrests being in other positions;

FIG. 5 is a top view of the seat shown on FIG. 1;

FIG. 6 is a side view of the backrest of the seat shown on FIG. 1 from which the backrest cushion has been removed;

FIG. 7 is a view similar to FIG. 6 of a seat according to a second embodiment;

FIG. 8a is a detailed view of a locking mechanism of the armrest of FIG. 7, the armrest being in stowed position;

FIG. 8b is a view similar to FIG. 7a, the armrest being in utilisation position;

FIG. 9 is a cross-sectional view through line IX-IX of FIG. 8b.

### DETAILED DESCRIPTION OF THE PREFERRED EMBODIMENT(S)

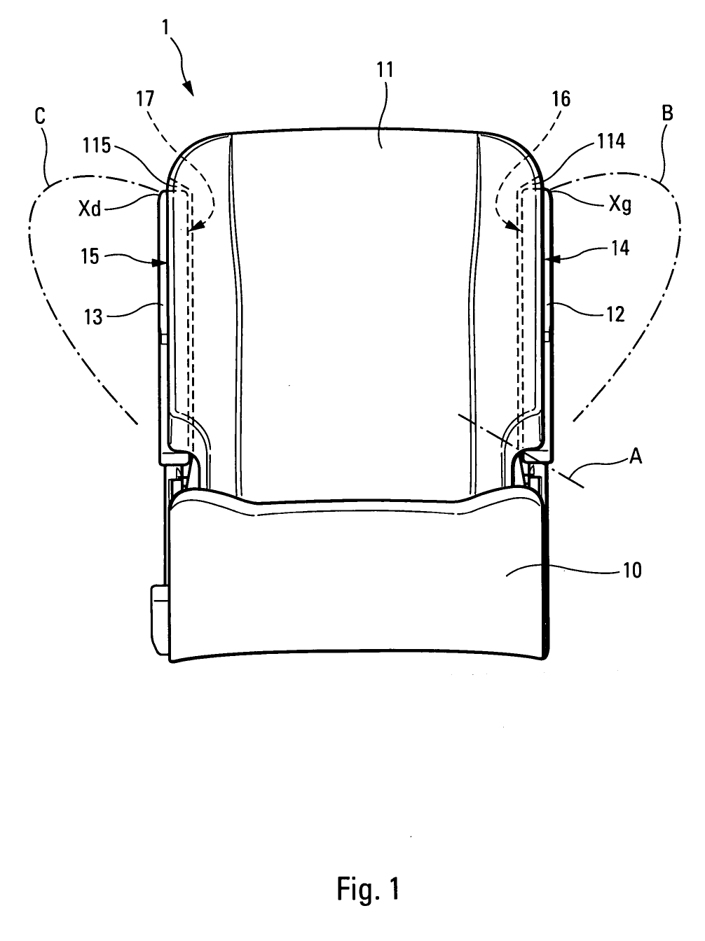

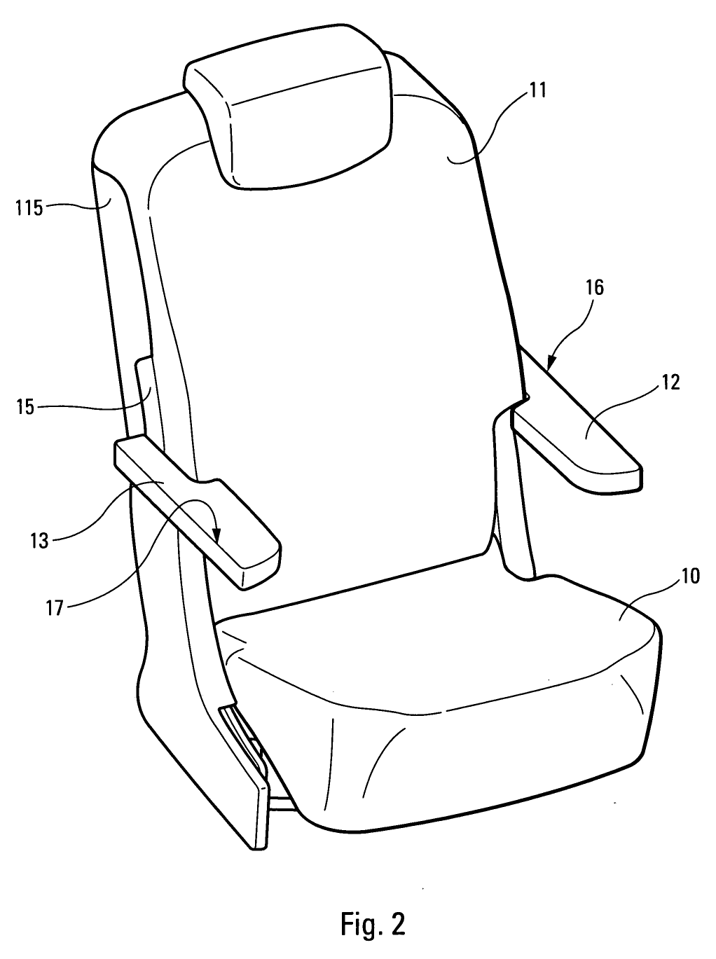

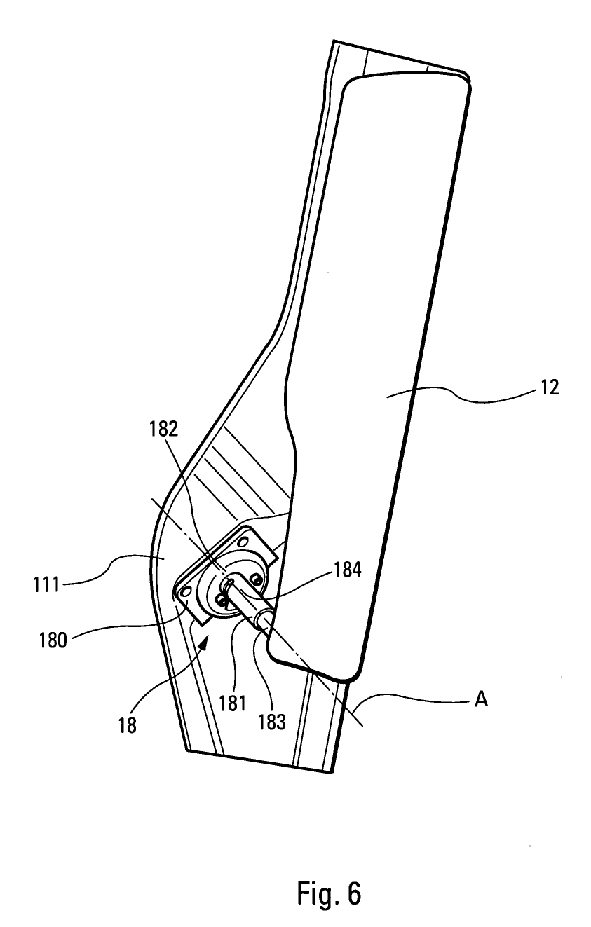

A seat 1 according to a first embodiment of the invention is shown on FIGS. 1 to 6. The seat 1 comprises a seat pan 10 installed mobile on the floor of a vehicle, not shown, and a backrest 11 installed in a conventional manner on the seat pan 10. The seat comprises two armrests 12, 13 installed so as to pivot on either side of the backrest 11. When the armrests 12, 13 are in a utilisation position, as shown on FIG. 2, they offer a bearing face 16, 17 for the arms of a user who would be sat in the seat on the seat pan 10, back bearing against a front face 110 of the backrest 11. In this position, the bearing face 16, 17 is stowed in relation to the seat pan 10 and is more or less horizontal. Possibly, it could be slightly inclined towards the rear. The thickness of the armrest 12, 13 is much lower than its width.

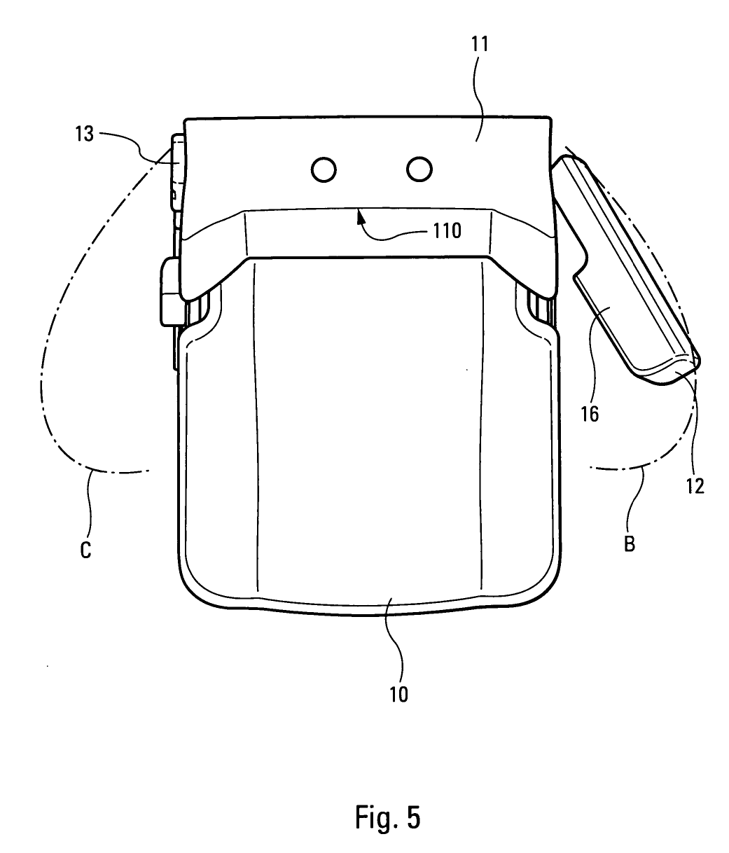

In a stowed position, the bearing face 16, 17 of the armrests 12, 13 is opposite a lateral face 14, 15 of the backrest 11, as shown on FIG. 1 and the LH part of FIG. 5. The lateral faces 14, 15 of the backrest 11 are more or less vertical and perpendicular to the front face 110 of the backrest 11. In the embodiment shown, the lateral faces 14, 15 comprise a recess 114, 115 in the cushion of the backrest 11 so that, in relation to the total widthwise overall size of the backrest 11, the armrests 12, 13 protrude slightly by an overthickness lower than the complete thickness of the armrest 12, 13. In some embodiments, not shown, the armrests could be completely housed in the recesses, without protruding beyond the lateral faces. The width of the armrests 12, 13 remains lower than the width of the lateral faces 14, 15 so that the armrest 12, 13 does not protrude beyond the backrest 11 either at the front or at the rear.

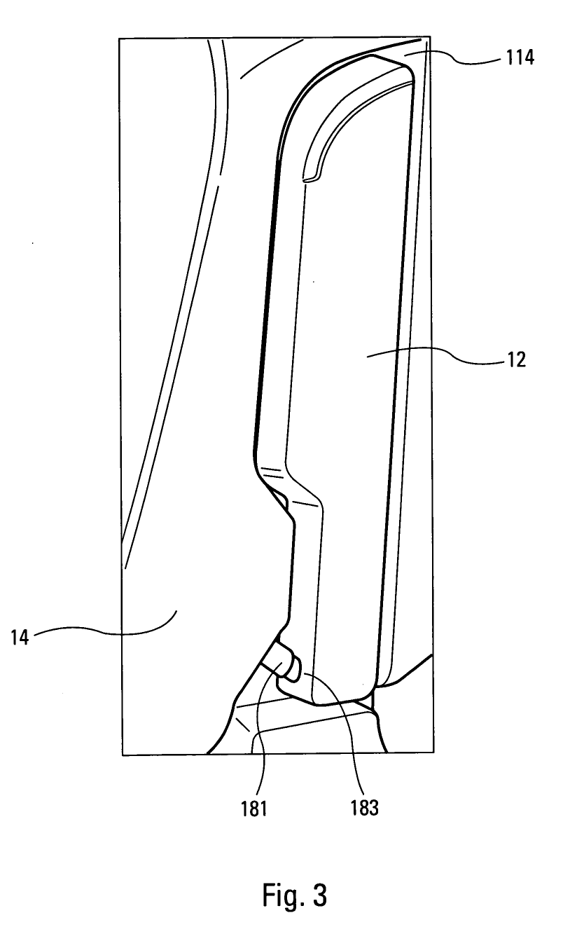

One of the armrests 12, the LH one, is shown on FIGS. 3 to 6. It is connected to a framework 111 of the backrest 11 by means of a pivot 18. The pivot 18 comprises a support plate 180 attached to the framework 111, a tube 181 attached to the support plate 180 and a journal 183 installed so as to pivot in the tube 181. The armrest 12 is attached to the journal 183. The tube 181 comprises a partially circumferential slot 182. A pin 184 is radially fitted into the journal 183 and protrudes into the slot 182 in such a way that the journal 183 is held trapped in the tube 181 with a pivoting freedom limited by the length of the slot 182. The pivot axis A is oriented downwards, towards the rear and towards the outside of the backrest 11, in reference to the normal utilisation position of the backrest 11 in a vehicle. The RH armrest 13 is made in a manner symmetrical to the LH armrest 12.

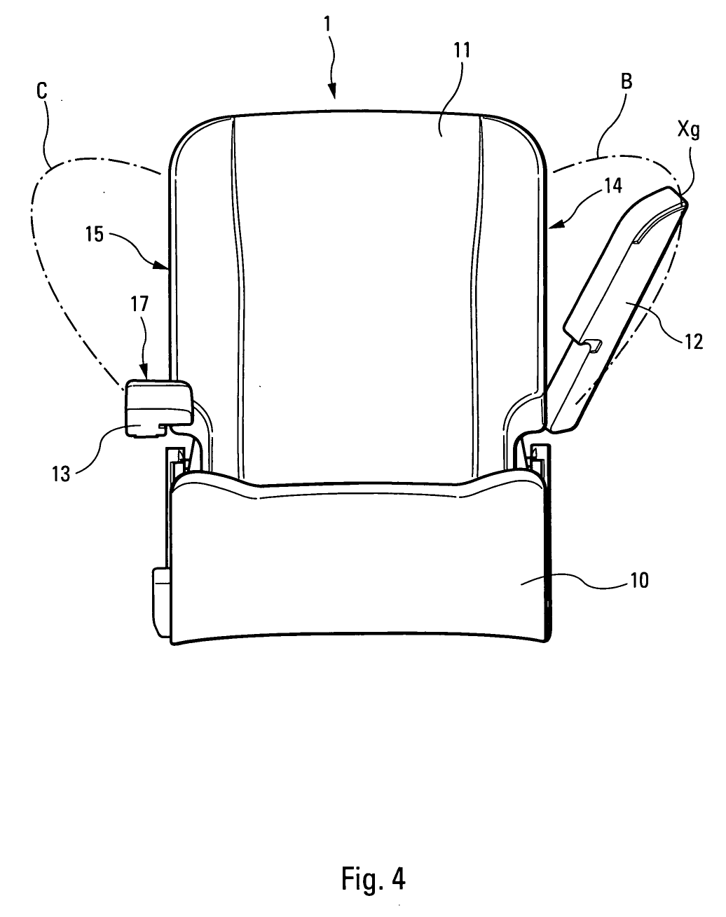

Thus, to use the armrest 12, it is pivoted around the pivot axis A to attain the utilisation position. A point Xg related to the LH armrest 12, at an end of the armrest, takes in this movement a circular trajectory B, shown by chain lines on FIGS. 1, 4 and 5. The RH part of FIG. 4 shows the armrest 12 in an intermediary position. In a symmetrical manner, a trajectory C of a point Xd of the RH armrest 13 is shown.

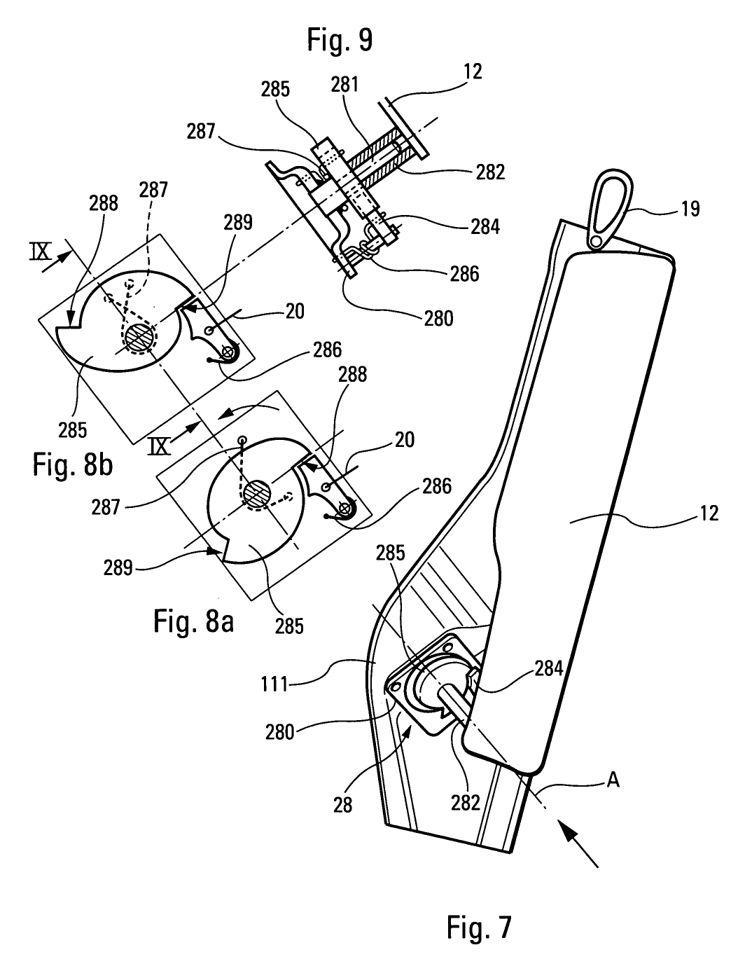

A second embodiment of the invention is shown on FIGS. 7 to 9. This second embodiment features an armrest position locking mechanism 28. On these figures, the same elements as those of the first embodiment are identified by the same references.

The support plate 280 supports a journal 281 on which the armrest is installed so as to pivot by means of a tube 282 fitted onto the journal. A cam 285 is attached to the end of the tube 282. The support plate 280 also supports a ratchet 284 held against the cam 285 by a first spring 286. A second spring 287 wound around the journal bears, on the one hand, on the support plate 280 and, on the other hand, on the cam 285. The second spring 287 tends to pivot the armrest from the stowed position towards the utilisation position.

The cam 285 comprises a first stop surface 288 against which the ratchet 284 bears when the armrest 12 is in stowed position and a second stop surface 289 against which the ratchet 284 bears when the armrest 12 is in utilisation position. The second spring 287 tends to maintain the stop surfaces 288, 289 against the ratchet 284. The armrest 11 also comprises a control handle 19 connected by a cable only the end of which is shown on FIGS. 8a and 8b. The end of the cable 20 is connected to the ratchet in such a way that the movement of the control handle 19 causes the ratchet 284 to pivot. Preferably, the second armrest 13 is attached to the control handle in the same manner.

When the armrest 12 is in stowed position, it is, on the one hand, in contact with the backrest and, on the other hand, the cam 285 is in contact by its first surface 288 with the ratchet 284 which prevents the armrest from moving to the utilisation position, as shown on FIG. 8a. By operating the control handle 19, the user pivots the ratchet 284 which retracts and thus allows the pivoting of the armrest 12 towards the utilisation position under the effect of the second spring 287. The armrest 12 is then in contact with the second cam stop surface. The armrest 13 is controlled simultaneously in the same manner.

When the user raises the armrest 12, the second spring 287 is compressed and the ratchet 284 pivots until the first stop surface 288 protrudes beyond the end of the ratchet 284. Under the effect of the first spring 286, the ratchet 284 is then placed opposite the first stop surface 288 and guarantees the retention of the armrest in stowed position.

Possibly, the pivots 18 could also be installed on a framework of the seat pan.

The invention is not limited to the embodiment described above only as an example. The armrests could have thicknesses equivalent to their width, with deep recesses.

1. Automobile vehicle seat comprising a backrest, at least one armrest installed so as to pivot around a pivoting axis between a utilisation position, in which the at least one armrest presents a bearing face more or less horizontal towards a front of the backrest and a stowed position in which the at least one armrest lies along a lateral face of the backrest, more or less vertical, and the pivoting axis being inclined with regard to the lateral face in such a way that, in the stowed position, the bearing face is opposite the lateral face of the backrest.

2. The automobile vehicle seat in accordance with claim 1, wherein the pivoting axis is inclined, from an outside of the lateral face, downwards and towards a rear of the backrest.

3. The automobile vehicle seat in accordance with claim 1, wherein the lateral face of the backrest comprises a recess in which the at least one armrest is housed in stowed position.

4. The automobile vehicle seat in accordance with claim 1, wherein the at least one armrest has a thickness much lower than its width.

5. The automobile vehicle seat in accordance with claim 1, wherein the pivoting axis consists of a pivot attached to a framework of the backrest.

6. The automobile vehicle seat in accordance with claim 1, further comprising locking means to maintain the at least one armrest in the stowed position and to free the at least one armrest on request.
